(19) United States
(12) Patent Application Publication
(10) Pub. No.: US 2013/0305875 A1
(43) Pub. Date: Nov. 21, 2013

(54) SCISSORS-TYPE LINKAGE ASSEMBLY

(71) Applicant: Qing ZHANG, Changshu (CN)

(72) Inventor: Qing ZHANG, Changshu (CN)

(21) Appl. No.: 13/473,794

(22) Filed: May 17, 2012

(51) Int. Cl. F16H 21/02

(52) U.S. Cl. 74/521

(57) ABSTRACT

A scissors-type linkage assembly for a key device includes: a first lever having a lever body and a pivot shaft, the pivot shaft having at least one arcuate portion and at least one non-arcuate portion; and a second lever formed with a pivot hole that receives the pivot shaft and that has a rounded hole portion and a non-rounded hole portion. The arcuate portion contacts slidably and rotatably a wall of the rounded hole portion. The non-rounded hole portion is wider than the non-arcuate portion. The non-arcuate portion is movable toward or away from a wall of the non-rounded hole portion and is capable of limiting an angle of rotation of the pivot shaft when contacting the wall of the non-rounded hole portion.

### BACKGROUND OF THE INVENTION

1. Field of the Invention

This invention relates to a linkage assembly, more particularly to a scissors-type linkage assembly for a key device.

2. Description of the Related Art

Referring to FIGS. 1 and 2, a conventional linkage assembly 1 for a key device has a scissors-type structure. A keycap 100 of the key device can be mounted to a base board (not shown) through the linkage assembly 1, so as to be movable upward and downward in accordance with user operation. The linkage assembly 1 includes a first lever 11 having a pivot shaft 111 and a second lever 12 having a pivot hole 121. Both of the pivot shaft 111 and the pivot hole 121 have circular cross sections.

The first and second levers 11, 12 are pivotally connected to each other by inserting the pivot shaft 111 into the pivot hole 121. Each of the first and second levers 11, 12 has one end coupled to the keycap 100. An angle defined between the first and second levers 11, 12 determines the position of the keycap 100.

In order to have sufficient supporting strength for the keycap 100 and to ensure that the pivot shaft 111 can stably rotate in the pivot hole 121, the diameter of the cross section of the pivot shaft 111 is preferably greater than 0.7 mm. Thus, the thicknesses of the first and second levers 11, 12 are required to be greater than 0.8 mm, which is adverse to the miniaturization of a key device.

### SUMMARY OF THE INVENTION

Therefore, an object of the present invention is to provide a scissors-type linkage assembly for a key device that can overcome the aforesaid drawback associated with the prior art.

Accordingly, a scissors-type linkage assembly for a key device of this invention comprises:

a first lever having a lever body and a pivot shaft that protrudes laterally from the lever body, the pivot shaft having at least one arcuate portion with a curvature centered at an axis of the pivot shaft, and at least one non-arcuate portion connected to the arcuate portion, the arcuate and non-arcuate portions being rotatable about the axis of the pivot shaft; and
a second lever formed with a pivot hole that receives the pivot shaft and that has a rounded hole portion centered at the axis of the pivot shaft, and a non-rounded hole portion.

The arcuate portion contacts slidably and rotatably a hole-defining wall of the rounded hole portion, the non-rounded hole portion is wider than the non-arcuate portion, and the non-arcuate portion is movable toward or away from a hole-defining wall of the non-rounded hole portion and is capable of limiting an angle of rotation of the pivot shaft when contacting the hole-defining wall of the non-rounded hole portion.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional scissors-type linkage assembly for a key device;

FIG. 2 illustrates movement between first and second levers of the scissors-type linkage assembly of FIG. 1;

FIG. 3 is a sectional view of the first preferred embodiment of a scissors-type linkage assembly for a key device according to this invention;

FIG. 4 is an enlarged fragmentary view of FIG. 3, showing a pivot shaft rotated in a pivot hole;

FIG. 5 illustrates movement between first and second levers of the scissors-type linkage assembly of FIG. 3;

FIG. 6 shows enlarged fragmentary views of the second preferred embodiment of a scissors-type linkage assembly for a key device according to this invention;

FIG. 7 shows enlarged fragmentary views of the third preferred embodiment of a scissors-type linkage assembly for a key device according to this invention;

FIG. 8 is a sectional view of the fourth preferred embodiment of a scissors-type linkage assembly for a key device according to this invention;

FIG. 9 is an enlarged fragmentary view of FIG. 8; and

FIG. 10 shows enlarged fragmentary views of the fifth preferred embodiment of a scissors-type linkage assembly for a key device according to this invention.

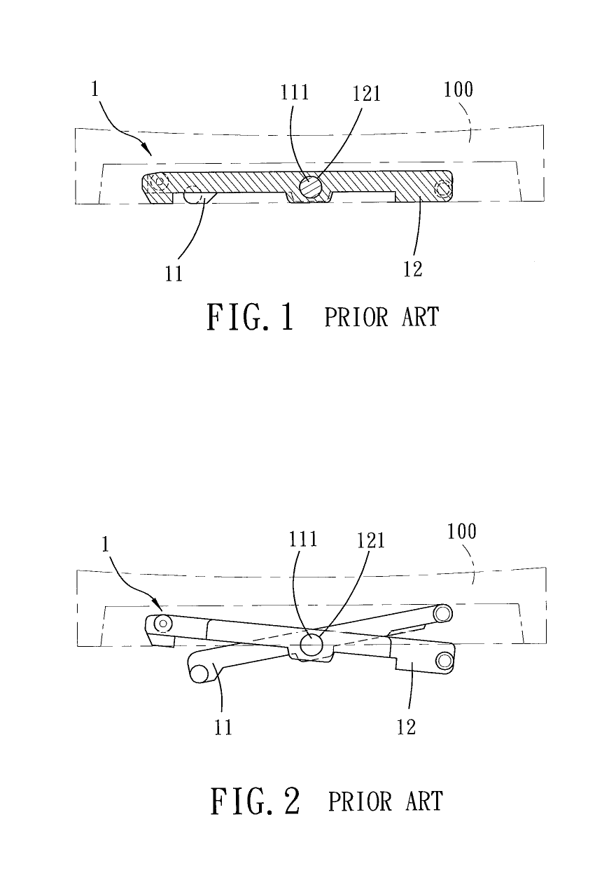

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

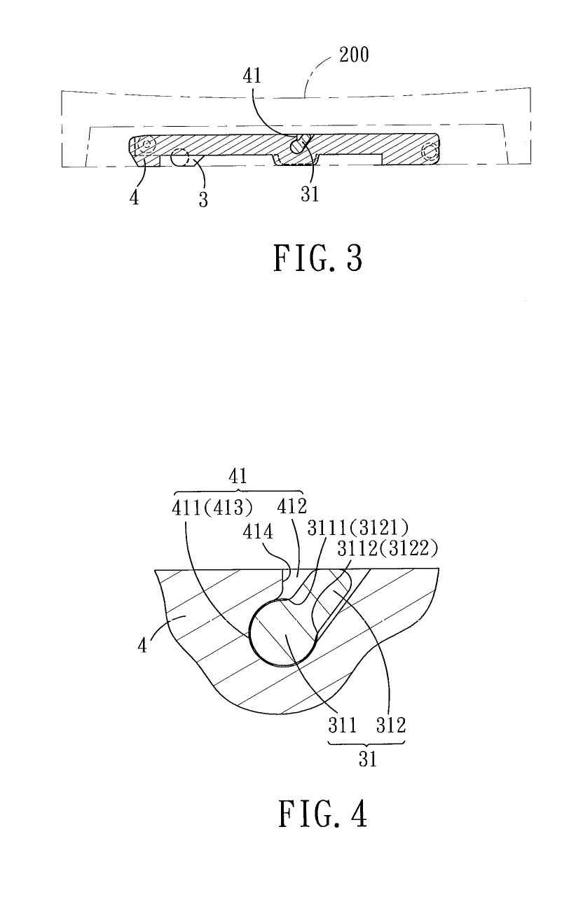

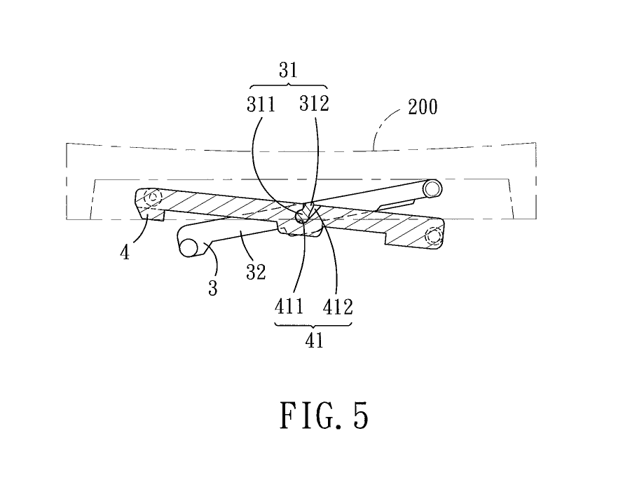

Referring to FIGS. 3 to 5, the first preferred embodiment of a scissors-type linkage assembly for a key device according to this invention includes first and second levers 3, 4 that are pivotally connected to each other. Each of the first and second levers 3, 4 has one end coupled to a keycap 200 of the key device, and the other end coupled to a base board (not shown) of the key device, such that the keycap 200 can move upward and downward with respect to the base board in accordance with user operation. Since the connections among the keycap 200, the scissors-type linkage assembly, and the base board are well-known in the art, a detailed description thereof is omitted herein for the sake of brevity.

The first lever 3 has a lever body 32 and a pivot shaft 31 that protrudes laterally from the lever body 32. The pivot shaft 31 has an arcuate portion 311 and a non-arcuate portion 312 connected to the arcuate portion 311. In this embodiment, the arcuate portion 311 is formed with a curvature centered at an axis of the pivot shaft 31, and the non-arcuate portion 312 extends substantially radially from the arcuate portion 311. The arcuate and non-arcuate portions 311, 312 are rotatable about the axis of the pivot shaft 31. In this embodiment, a cross section of the arcuate portion 311 has a diameter of 0.4 mm.

The second lever 4 is formed with a pivot hole 41 that receives the pivot shaft 31, and that has a rounded hole portion 411 and a non-rounded hole portion 412. The rounded hole portion 411 is centered at the axis of the pivot shaft 31.

The arcuate portion 311 contacts slidably and rotatably a hole-defining wall 413 of the rounded hole portion 411. The non-rounded hole portion 412 is wider than the non-arcuate portion 312. The non-arcuate portion 312 is movable toward or away from a hole-defining wall 414 of the non-rounded hole portion 412 and is capable of limiting an angle of rotation of the pivot shaft 31 when contacting the hole defining wall 414 of the non-rounded hole portion 412. Accordingly, the displacement of the keycap 200 can be limited, and the thickness of the key device may be reduced.

As best shown in FIG. 4, in this embodiment, the arcuate portion 311 has a cross sectional shape conforming to a segment of a circle. The arcuate portion 311 has two ends 3111, 3112 that are opposite to each other in a chordal direction of a cross section of the arcuate portion 311. The non-arcuate portion 312 has two ends 3121, 3122 connected respectively to the two ends 3111, 3112 of the arcuate portion 311. The hole-defining wall 414 of the non-rounded hole portion 412 is a surrounding wall to surround the non-arcuate portion 312, and is flared from the hole-defining wall 413 of the rounded hole portion 411. The non-arcuate portion 312 is movable between two opposite sides of the hole-defining wall 414. When the arcuate portion 311 slidably and rotatably moves along the hole-defining wall 413 of the rounded hole portion 411, the non-arcuate portion 312 moves from one side of the hole-defining wall 414 toward the other side of the hole-defining wall 414. Accordingly, the range of angular rotation of the pivot shaft 31 is limited by the hole-defining wall 414 of the non-rounded hole portion 412.

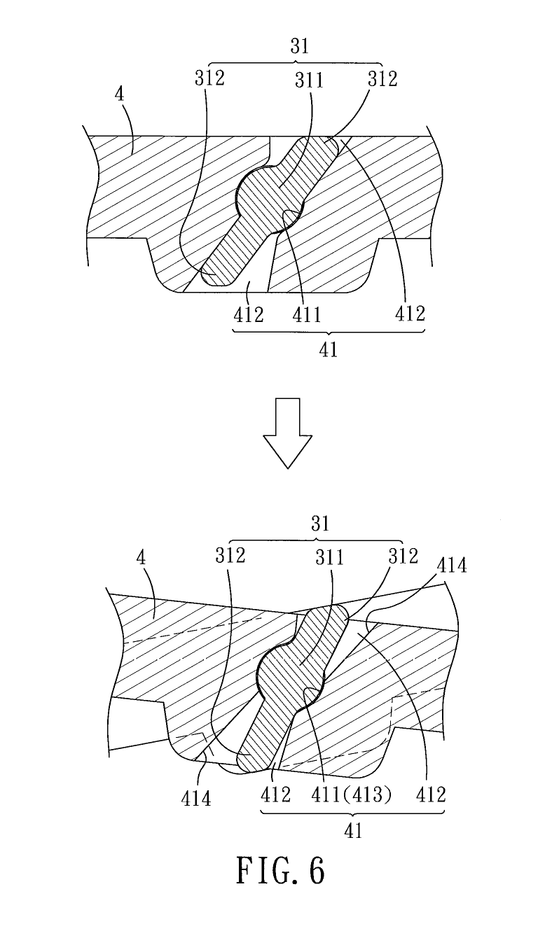

FIG. 6 illustrates the second preferred embodiment of a scissors-type linkage assembly of this invention.

This embodiment is similar to the first embodiment, except that, in this embodiment, the pivot shaft 31 has two of the non-arcuate portions 312, and the arcuate portion 311 is substantially circular in cross section. The non-arcuate portions 312 are opposite to each other substantially in a diametrical direction.

In addition, the pivot hole 41 has the rounded hole portion 411 and two of the non-rounded hole portions 412. The hole-defining wall 413 of the rounded hole portion 411 contacts slidably and rotatably the arcuate portion 311. The hole-defining walls 414 of the two non-rounded hole portions 412 are formed oppositely in the diametrical direction. Each of the hole-defining walls 419 is a surrounding wall to surround a respective one of the non-arcuate portions 312, and is flared from the hole-defining wall 413 of the rounded hole portion 411. Each of the non-arcuate portions 312 is movable between two opposite sides of the hole-defining wall 414 of a respective one of the non-rounded hole portions 412. When the arcuate portion 311 slidably and rotatably moves along the hole-defining wall 413 of the rounded hole portion 411, each of the non-arcuate portions 312 moves from one side of the hole-defining wall 414 of the respective one of the non-rounded hole portions 412 to the other side. Accordingly, the range of angular rotation of the pivot shaft 31 is limited by the hole-defining walls 414 of the non rounded hole portions 412.

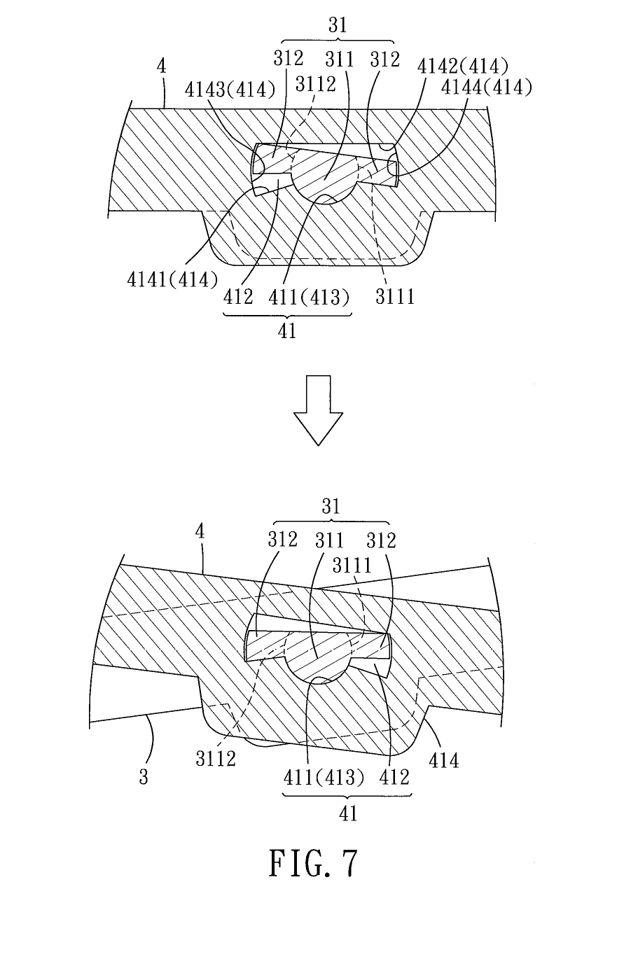

FIG. 7 illustrates the third preferred embodiment of a scissors-type linkage assembly of this invention.

In this embodiment, the pivot shaft 31 has two of the non-arcuate portions 312. The arcuate portion 311 has a cross sectional shape conforming to a major segment of a circle, and has two ends 3111, 3112 that are opposite to each other in a chordal direction of the cross section of the arcuate portion 311. The non-arcuate portions 312 extend oppositely and respectively from the two ends 3111, 3112 of the arcuate portion 311.

The hole-defining wall 414 of the non-rounded hole portion 412 of the pivot hole 41 has first, second, third and fourth wall segments 4141, 4142, 4143, 4144. The first wall segment 4141 is connected to the hole-defining wall 413 of the rounded hole portion 411. The second wall segment 4142 is spaced apart from the first wall segment 4141. The third and fourth wall segments 4143, 4144 are opposite to each other, each of which interconnects the first and second wall segments 4141, 4142. When the arcuate portion 311 slidably and rotatably moves along the hole-defining wall 413 of the rounded hole portion 411, one of the non-arcuate portions 312 moves away from the first wall segment 4141 to the second wall segment 4142, and the other of the non-arcuate portions 312 moves away from the second wall segment 4142 to the first wall segment 4141. Accordingly, the range of angular rotation of the pivot shaft 31 is limited by the hole-defining wall 414 of the non-rounded hole portion 412.

It should be noted that although the non-arcuate portions 312 are formed symmetrically in FIG. 7, they may have different sizes and shapes and should not be limited to the configuration of this embodiment.

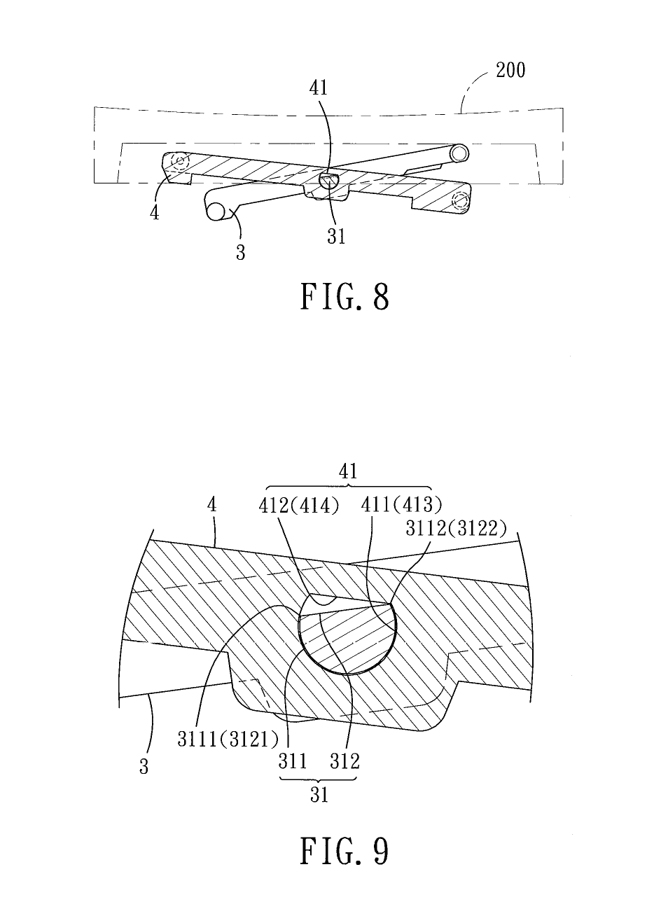

FIGS. 8 and 9 illustrate the fourth preferred embodiment of a scissors-type linkage assembly of this invention.

The pivot shaft 31 has a cross sectional shape conforming to a major segment of a circle, an arcuate surface of the major segment forms the arcuate portion 311, and a chordal surface of the major segment forms the non-arcuate portion 312. The arcuate portion 311 has two ends 3111, 3112 that are opposite to each other in a chordal direction of the major segment. The non-arcuate portion 312 has two ends 3121, 3122 connected respectively to the two ends 3111, 3112 of the arcuate portion 311.

The pivot hole 41 has a cross sectional shape conforming to a major segment of a circle. The space of the major segment of the pivot hole 41 is larger than the volume of the pivot shaft 31. An arcuate surface of the major segment of the pivot hole 41 forms the hole-defining wall 413 of the rounded hole portion 411, and a chordal surface of the major segment of the pivot hole 41 forms the hole-defining wall 414 of the non-rounded hole portion 412.

When the arcuate portion 311 slidably and rotatably moves along the hole-defining wall 413 of the rounded hole portion 411, one of the two ends 3111, 3112 moves toward the hole-defining wall 414 of the non-rounded hole portion 412, and the other one of the two ends 3111, 3112 moves away from the hole-defining wall 414 of the non-rounded hole portion 412. Accordingly, the range of angular rotation of the pivot shaft 31 is limited by the hole-defining wall 414 of the non-rounded hole portion 412.

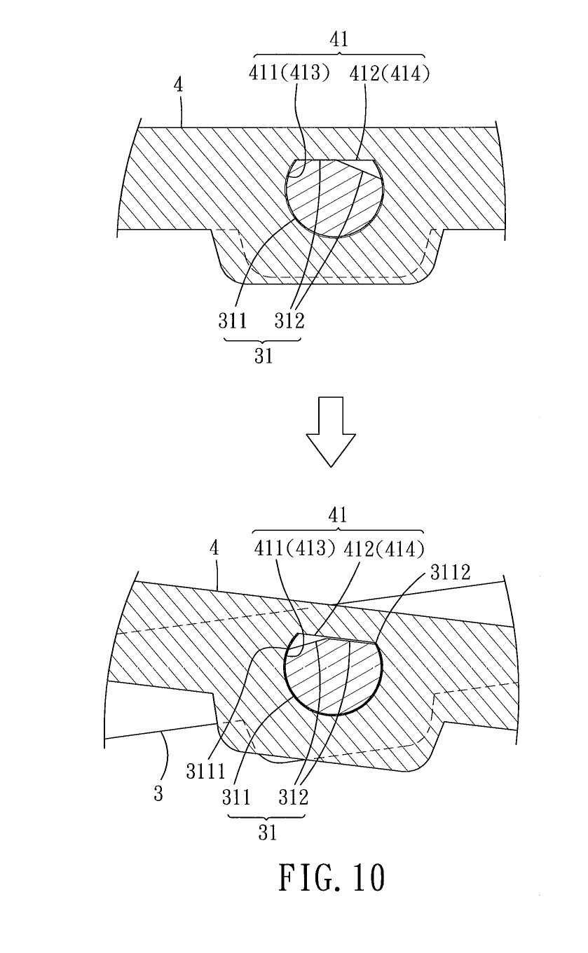

FIG. 10 illustrates the fifth preferred embodiment of a scissors-type linkage assembly of this invention.

The pivot shaft 31 of this embodiment is similar to that of the fourth embodiment, except that, in this embodiment, the major segment of the pivot shaft 31 is beveled at a corner between the arcuate surface and the chordal surface. Accordingly, in this embodiment, the chordal surface and the beveled surface of the major segment form two non-arcuate portions 312 of the pivot shaft 31. With the beveled pivot shaft 31, the thickness of the first and second levers 3, 4 can be further reduced. In this embodiment, the pivot shaft 31 has an arc radius of 0.35 mm.

The shape of the pivot hole 41 of this embodiment is the same as that of the fourth embodiment.

When the arcuate portion 311 slidably and rotatably moves along the hole-defining wall 413 of the rounded hole portion 411, one of the two ends 3111, 3112 moves toward the hole-defining wall 414 of the non-rounded hole portion 412, and the other one of the two ends 3111, 3112 moves away from the hole-defining wall 414 of the non-rounded hole portion 412. Accordingly, the range of angular rotation of the pivot shaft 31 is limited by the hole-defining wall 414 of the non-rounded hole portion 412.

To sum up, with the specific designs of the pivot shaft 31 and the pivot hole 41, the range of angular rotation of the pivot shaft 31 can be limited, thereby limiting the displacement of the keycap 200. Moreover, in this invention, the first and second levers 3, 4 have reduced thicknesses, and the pivot shaft 31 is less likely to break and can rotate smoothly in the pivot hole 41. Thus, the first and second levers 3, 4 can be firmly connected with each other so as to support the keycap 200.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A scissors-type linkage assembly for a key device, comprising:
a first lever having a lever body and a pivot shaft that protrudes laterally from said lever body, said pivot shaft having at least one arcuate portion with a curvature centered at an axis of said pivot shaft, and at least one non-arcuate portion connected to said arcuate portion, said arcuate and non-arcuate portions being rotatable about the axis of said pivot shaft; and
a second lever formed with a pivot hole that receives said pivot shaft and that has a rounded hole portion centered at said axis of said pivot shaft, and a non-rounded hole portion;
said arcuate portion contacting slidably and rotatably a hole-defining wall of said rounded hole portion, said non-rounded hole portion being wider than said non-arcuate portion, said non-arcuate portion being movable toward or away from a hole-defining wall of said non-rounded hole portion and being capable of limiting an angle of rotation of said pivot shaft when contacting said hole-defining wall of said non-rounded hole portion.

2. The scissors-type linkage assembly of claim 1, wherein said non-arcuate portion extends substantially radially from said arcuate portion.

3. The scissors-type linkage assembly of claim 2, wherein said arcuate portion has a cross sectional shape conforming to a segment of a circle.

4. The scissors-type linkage assembly of claim 3, wherein said arcuate portion has two ends that are opposite to each other in a chordal direction, said non-arcuate portion having two ends connected respectively to said two ends of said arcuate portion.

5. The scissors-type linkage assembly of claim 3, wherein said pivot shaft has two of said non-arcuate portions, said arcuate portion having two ends that are opposite to each other in a chordal direction, said non-arcuate portions extending oppositely and respectively from said two ends of said arcuate portion.

6. The scissors-type linkage assembly of claim 2, wherein said pivot shaft has two of said non-arcuate portions, said arcuate portion being substantially circular in cross section, said non-arcuate portions being opposite to each other substantially in a diametrical direction.

7. The scissors-type linkage assembly of claim 1, wherein said pivot shaft has a cross sectional shape conforming to a segment of a circle, an arcuate surface of said segment forming said arcuate portion, a chordal surface of said segment forming said non-arcuate portion.

8. The scissors-type linkage assembly of claim 7, wherein said segment of said pivot shaft is beveled at a corner between said arcuate surface and said chordal surface.
